(19) United States
(12) Patent Application Publication
(10) Pub. No.: US 2025/0232378 A1
(43) Pub. Date: Jul. 17, 2025

(54) ENVIRONMENTAL ATTRIBUTES FOR FORMULATION ADDITIVES

(71) Applicant: BASF SE, Ludwigshafen am Rhein (DE)

(72) Inventors: Bastian GRUMBRECHT, Ludwigshafen am Rhein (DE); Steffen KLOSTERHALFEN, Ludwigshafen am Rhein (DE); Christian KRUEGER, Ludwigshafen am Rhein (DE); Ana ALBA PEREZ, Ludwigshafen am Rhein (DE); Christopher Alec ANDERLOHR, Ludwigshafen am Rhein (DE); Martin BINDER, Ludwigshafen am Rhein (DE); Alessandro PISTILLO, Ludwigshafen am Rhein (DE); Martin KLATT, Ludwigshafen am Rhein (DE); Kurt WENZL, Ludwigshafen am Rhein (DE)

(21) Appl. No.: 18/719,319

(22) PCT Filed: Dec. 19, 2022
(86) PCT No.: PCT/EP2022/086772

§ 371 Date: Jun. 13, 2024

Related U.S. Application Data
(60) Provisional application No. 63/416,091, filed on Oct. 14, 2022.

(30) Foreign Application Priority Data
Dec. 21, 2021 (EP) 21216292.9
Dec. 21, 2021 (EP) 21216326.5
Dec. 21, 2021 (EP) 21216327.3
Dec. 21, 2021 (EP) 21216333.1
Oct. 18, 2022 (EP) 10182022
Dec. 5, 2022 (EP) 22211421.7

(51) Int. Cl. G06Q 40/06; C08F 20/06

(52) U.S. Cl. CPC G06Q 40/06; C08F 20/06

(57) ABSTRACT

Disclosed are systems for producing a formulation additive associated with a digital asset, methods for producing a formulation additive associated with a digital asset, apparatuses for generating a digital asset, computer-implemented methods for generating a chemical passport, computer program elements for generating a digital asset, uses of a formulation additive associated with a digital asset, uses of a digital asset, products produced from the formulation additive and associated with a digital asset, a digital asset including one or more decentral identifiers) and data related to the environmental impact data, apparatuses for producing a product associated with the digital asset and methods for producing a product associated with the digital asset.

### TECHNICAL FIELD

The present disclosure relates to systems for producing a formulation additive associated with a formulation additive passport or digital asset, methods for producing a formulation additive associated with a formulation additive passport or digital asset, apparatuses for generating a formulation additive passport or digital asset, computer-implemented methods for generating a chemical passport, computer program elements for generating a formulation additive passport or digital asset, uses of a formulation additive associated with a formulation additive passport or digital asset, uses of a formulation additive passport or digital asset, products produced from the formulation additive and associated with a formulation additive passport or digital asset, a formulation additive, a formulation additive passport or digital asset including one or more decentral identifier(s) and data related to the environmental impact data, apparatuses for producing a product associated with the formulation additive passport or digital asset and methods for producing a product associated with the formulation additive passport or digital asset.

### TECHNICAL BACKGROUND

In supply chains the environmental impact of each supply chain participants is of great interest. Specifically in the field of chemistry, formulation additive are employed for a wide range of applications and are supplied to diverse value chains. In such complex systems transparency between value chain participants is hard to achieve.

### SUMMARY OF THE INVENTION

In one aspect disclosed is a system for producing a formulation additive associated with a formulation additive passport or a digital asset, the system comprising:
a chemical production network configured to produce the formulation additive wherein the formulation additive is produced from one or more input material(s) through one or more chemical process(s) of the chemical production network, wherein the one or more input material(s) and/or the one or more chemical process(s) are associated with environmental attribute(s);
a production operating apparatus configured to generate the formulation additive passport or digital asset by providing a decentral identifier associated with the produced formulation additive and one or more environmental attribute(s) of the one or more input material(s) and/or the one or more chemical process(s);
linking the decentral identifier and the environmental attribute(s);
a chemical production network or system configured to provide each produced formulation additive in association with the digital asset.

In another aspect disclosed is a system for producing a formulation additive associated with a formulation additive passport or digital asset, the system comprising:
a chemical production network configured to produce the formulation additive from one or more input material(s) through chemical process(s), wherein the one or more input material(s) and/or the chemical process(s) are associated with environmental attribute(s);
a production operating apparatus configured to generate the formulation additive passport or digital asset by providing and/or linking a decentral identifier associated with the formulation additive and one or more environmental attribute(s) associated with the one or more input material(s) and/or the chemical process(s).

In another aspect disclosed is a method for producing a formulation additive associated with a formulation additive passport or digital asset, wherein the method comprises:
producing the formulation additive from one or more input material(s) through one or more chemical process(s) of a chemical production network, wherein the one or more input material(s) and/or the one or more chemical process(s) are associated with environmental attribute(s);
generating the formulation additive passport or digital asset by providing a decentral identifier associated with the produced formulation additive and one or more environmental attribute(s) associated with the one or more input material(s) and/or the one or more chemical process(s);
linking the decentral identifier and the one or more environmental attribute(s);
providing the produced formulation additive in association with the formulation additive passport or digital asset.

In another aspect disclosed is a method for producing a formulation additive associated with a formulation additive passport or a digital asset, wherein the method comprises:
producing the formulation additive from one or more input material(s) through one or more chemical process(s) of a chemical production network, wherein the one or more input material(s) and/or the one or more chemical process(s) are associated with environmental attribute(s),
generating the formulation additive passport or digital asset by providing and/or linking a decentral identifier associated with the formulation additive and one or more environmental attribute(s) of the one or more input material(s) and/or the chemical process(s).

In another aspect disclosed is an apparatus for generating a passport or digital asset associated with a formulation additive, wherein the formulation additive is produced from one or more input material(s) through one or more chemical process(s) of a chemical production network, wherein the one or more input material(s) and/or the one or more chemical process(s) are associated with environmental attribute(s), the apparatus comprising:
providing a decentral identifier associated with the produced formulation additive and one or more environmental attribute(s) of the one or more input material(s) and/or the one or more chemical process(s) used to produce the formulation additive;
linking the decentral identifier and the environmental attribute(s);
providing the formulation additive passport or digital asset in association with the produced formulation additive e.g. to a decentral network, wherein the environmental attribute(s) associated with the formulation additive is made accessible to a user of the formulation additive through the formulation additive passport or digital asset.

In another aspect disclosed is a method, e.g. a computer-implemented method, for generating a formulation additive passport or digital asset associated with a formulation additive, wherein the formulation additive is produced from one or more input material(s) through one or more chemical process(s) of a chemical production network, wherein the one or more input material(s) and/or the one or more chemical process(s) are associated with environmental attribute(s), the method comprising:
providing a decentral identifier associated with the produced formulation additive and one or more environmental attribute(s) of the one or more input material(s) and/or the one or more chemical process(s) used to produce the formulation additive;
linking the decentral identifier and the environmental attribute(s);
providing the formulation additive passport or digital asset in association with the produced formulation additive e.g. to a decentral network, wherein the environmental attribute(s) associated with the formulation additive is made accessible to a user of the formulation additive through the formulation additive passport or digital asset.

In another aspect disclosed is a computer element, such as a computer readable storage medium, a computer program or a computer program product, comprising instructions, which when executed by a computing node or a computing system, direct the computing node or computing system to carry out the steps of the computer-implemented methods disclosed herein.

In another aspect disclosed is a computer element, such as a computer readable storage medium, a computer program or a computer program product, comprising instructions, which when executed by the apparatuses disclosed herein, direct the apparatuses to carry out steps the apparatuses disclosed herein are configured to execute.

In another aspect disclosed is a formulation additive associated with a formulation additive passport or a digital asset as produced according to the methods disclosed herein. In another aspect disclosed is a formulation additive associated with a formulation additive passport or digital asset as produced according to the systems disclosed herein.

In another aspect disclosed is a formulation additive associated with a formulation additive passport or digital asset, wherein the formulation additive is produced from one or more input material(s) through one or more chemical process(s) of a chemical production network, wherein the one or more input material(s) and/or the one or more chemical process(s) are associated with environmental attribute(s), wherein the formulation additive passport or digital asset includes a decentral identifier associated with the produced queous polymeric composition and/or formulations using said aqueous polymeric compositions and a link to environmental attribute(s) associated with one or more environmental attribute(s) of one or more input material(s) and/or one or more chemical process(s) used to produce the formulation additive.

In another aspect disclosed is a formulation additive passport or digital asset as generated according to the methods disclosed herein. In another aspect disclosed is a formulation additive passport or digital asset as generated according to the apparatuses disclosed herein.

In another aspect disclosed is a production system for producing a product from the formulation additive associated with the formulation additive passport or digital asset as provided according to the systems, apparatuses or methods disclosed herein. In another aspect disclosed is a production method for producing a product from the formulation additive associated with the formulation additive passport or digital asset as provided according to the systems, apparatuses or methods disclosed herein.

In another aspect disclosed is a use of the formulation additive associated with the formulation additive passport or digital asset as disclosed herein for producing a product from the formulation additive associated with the formulation additive passport or digital asset.

In another aspect disclosed is a use of the formulation additive passport or digital asset as disclosed herein for generating a product passport or digital asset associated with a product produced from the formulation additive associated with the formulation additive passport or digital asset. In another aspect disclosed is a method for using the digital asset generated according to the methods disclosed herein in production of a product produced from the formulation additive associated with the formulation additive passport or digital asset.

In another aspect disclosed is a formulation additive associated with a digital asset including a decentral identifier associated with the formulation additive and linked to one or more environmental attribute(s) of the one or more input material(s) and/or the one or more chemical process(s) used to produce the formulation additive.

In another aspect disclosed is a use of the formulation additive associated with the formulation additive passport or digital asset for producing a product from the formulation additive and associating the formulation additive passport or digital asset with the product produced from the formulation additive. In another aspect disclosed is a use of the formulation additive associated with the formulation additive passport or digital asset for producing a product from the formulation additive and deriving a product passport or digital asset from the formulation additive passport or digital asset. In another aspect disclosed is a method for using the formulation additive associated with the digital asset for producing a product from the formulation additive as disclosed herein and deriving a digital asset associated with the product from the formulation additive passport or formulation additive digital asset.

Any disclosure and embodiments described herein relate to the methods, the systems, chemical products, formulation additive, formulation additive passports, digital assets and the computer elements lined out above and below. Advantageously, the benefits provided by any of the embodiments and examples equally apply to all other embodiments and examples.

### EMBODIMENTS

In the following, embodiments of the present disclosure will be outlined by ways of embodiments and/or example. It is to be understood that the present disclosure is not limited to said embodiments and/or examples.

Determining, generating includes initiating or causing to determine, generate. Providing includes “initiating or causing to access, determine, generate, send or receive”. “Initiating or causing to perform an action” includes any processing signal that triggers a computing node to perform the respective action.

The methods, the systems, formulation additive, formulation additive passports, digital assets and the computer elements disclosed herein provide an efficient, secure and robust way for sharing or exchanging environmental impact data across different participant nodes in value chains. In particular, by providing formulation additive specific data via the formulation additive passport or digital asset, environmental impacts can be shared and made transparent from the material to the product produced from such material. The formulation additive passport or digital asset enables secure data exchange, since data access can be controlled by the formulation additive provider. The exchanged data assets can be specific to the formulation additive as produced and tailored to the needs of the formulation additive user. This way an improved tracking and tracing of formulation additive can be achieved by securely providing environmental impact data in diverse and highly complex value chains. The environmental impact of formulation additive can hence be tracked leading to simpler, more efficient and sustainable handling of formulation additive by value chain participants.

In an embodiment, formulation additive being associated with the composition passport or digital asset may be selected from liquid formulations which are modified by at least one formulation additive to improve and/or modify at least one of the following properties of the liquid formulation: rheology, wetting, hydrophobicity, film formation, coalescence, minimum film formation temperature, surface properties, dispersion power, emulsifying power (surface tension), flowability, reduced foaming or defoaming, adhesion, slipping, plastiziser, open time prolongation and/or stabilization against light, heat or chemicals, etc.

Formulation additive associated with the formulation additive passport or digital asset may be selected from e.g. stabilizers, UV stabilizers such as UV absorbers and suitable free-radical scavengers (more particularly HALS compounds—hindered amine light stabilizers), activators (accelerants), driers, extenders, pigments, dyes, antistatic agents, flame retardants, thickeners, thixotropic agents, surface-active agents, viscosity modifiers, plasticizers or chelating agents, wetting agents, dispersion agents, emulsifier, defoaming agent, film forming agent/Coalescent, agents to reduce minimum film formation temperature, open time prolonger, slipping agents, etc.

Stabilizers are at least one compound with stabilizing effect, “stabilizing” denoting the capacity to reduce the development of a color number and/or of the viscosity of the dispersion in the course of storage over a certain time period relative to those corresponding mixtures which comprise no compounds with stabilizing effect.

These compounds with stabilizing effect are preferably selected from the group consisting of primary antioxidants (free-radical scavengers), secondary antioxidants (compounds which prevent radicals being formed, more particularly by scavenging and/or decomposing peroxides), and acidic stabilizers (Bronsted acids).

The primary antioxidants are preferably sterically hindered phenols. Such sterically hindered phenols are described for example in WO 2008/116894, preferably the compounds described therein from page 14, line 10 to page 16, line 10, hereby incorporated by reference as part of the present disclosure content.

The phenols in question are preferably those which have exactly one phenolic hydroxyl group on the aromatic ring, and more preferably those which have any desired substituent, preferably an alkyl group, in the ortho-positions, very preferably in ortho- and para-position to the phenolic hydroxyl group, more particularly alkyl 3-(3,5-di-tert-butyl-4-hydroxyphenyl)propionates, or substituted alkyl derivatives of such compounds.

In conjunction with additives of the invention they are part of the invention, preferably 2,6-di-tertbutyl-4-methylphenol (BHT); isooctyl 3-(3,5-di-tert-butyl-4-hydroxyphenyl)propionate (e.g., Irganox® 1135), octadecyl 3-(3,5-di-tert-butyl-4-hydroxyphenyl)propionate (e.g. Irganox® 1076).

Such phenols may also be constituents of a polyphenolic system with a plurality of phenol groups: pentaerythritol tetrakis(3-(3,5-di-tert-butyl-4-hydroxyphenyl)propionate) (e.g., Irganox® 1010); ethylene bis(oxyethylene)bis(3-(5-tert-butyl-4-hydroxy-m-tolyl)propionate) (e.g., Irganox 245); 3,3′,3″,5,5′,5″-hexa-tert-butyl-a,a′,a″-(mesitylene-2,4,6-triyl)tri-p-cresol (e.g., Irganox® 1330); 1,3,5-tris(3,5-di-tert-butyl-4-hydroxybenzyl)-1,3,5-triazine-2,4,6(1H,3H,5H)-trione (e.g., Irganox® 3114), in each case products of Ciba Spezialitätenchemie, now BASF SE.

The secondary antioxidants are preferably selected from the group consisting of phosphonites, phosphonates, and thioethers, preferably from phosphonites or phosphonates.

Preferred phosphonites are described in WO 2008/116894, particularly from page 11, line 8 to page 14, line 8, therein, hereby made part of the present disclosure content by reference.

Preferred phosphonates are described in WO 2008/116895, particularly from page 10, line 38 to page 12, line 41, therein, hereby made part of the present disclosure content by reference.

These latter phosphonites and phosphonates differ from the compounds a3) and a4), respectively, used in accordance with the invention not least in that they fulfill a different purpose in the composition, namely an antioxidative effect, compared with the antiflocculant effect in accordance with the present invention.

Preferred thioethers are described in WO 2008/116893, particularly from page 11, line 1 to page 15, line 37, therein, hereby made part of the present disclosure content by reference.

The acidic stabilizers are Bronsted acids, as described in WO 2008/116894, particularly from page 17, line 34 to page 18, line 23, therein, hereby made part of the present disclosure content by reference.

Suitable UV absorbers comprise oxanilides, triazines and benzotriazoles (the latter available, for example, as Tinuvin® products from BASF SE) and benzophenones (e.g., Chimassorb® 81 from BASF SE). Preference is given, for example, to 95% benzenepropanoic acid, 3-(2H-benzotriazol-2-yl)-5-(1,1-dimethylethyl)-4-hydroxy-, C7-9-branched and linear alkyl esters; 5% 1-methoxy-2-propyl acetate (e.g., Tinuvin® 384) and α-[3-[3-(2H-benzotriazol-2-yl)-5-(1,1-dimethylethyl)-4-hydroxyphenyl]-1-oxopropyl]-w-hydroxypoly(oxo-1,2-ethanediyl) (e.g., Tinuvin® 1130), in each case products, for example, of BASF SE. DL-alpha-Tocopherol, tocopherol, cinnamic acid derivatives, and cyanoacrylates can likewise be used for this purpose.

These can be employed alone or together with suitable free-radical scavengers, examples being sterically hindered amines (often also identified as HALS or HAS compounds; hindered amine (light) stabilizers) such as 2,2,6,6-tetramethylpiperidine, 2,6-di-tert-butylpiperidine or derivatives thereof, e.g., bis(2,2,6,6-tetramethyl-4-piperidyl) sebacate. They are obtainable, for example, as Tinuvin® products and Chimassorb® products from BASF SE. Preference in joint use with Lewis acids, however, is given to those hindered amines which are N-alkylated, examples being bis(1,2,2,6,6-pentamethyl-4-piperidinyl) [[3,5-bis(1,1-dimethylethyl)-4-hydroxyphenyl]methyl]butylmalonate (e.g., Tinuvin® 144 from BASF SE); a mixture of bis(1,2,2,6,6-pentamethyl-4-piperidinyl)sebacate and methyl(1,2,2,6,6-pentamethyl-4-piperidinyl) sebacate (e.g., Tinuvin® 292 from BASF SE); or which are N—(O-alkylated), such as, for example, decanedioic acid bis(2,2,6,6-tetramethyl-1-(octyloxy)-4-piperidinyl) ester, reaction products with 1,1-dimethylethyl hydroperoxide and octane (e.g., Tinuvin® 123 from BASF SE) and especially with the HALS triazine 2,4-bis[N-butyl-N-(1-cyclohexyloxy-2,2,6,6-tetramethylpiperidin-4-yl)amino]-6-(2-hydroxyethyl-amine)-1,3,5-triazine (e.g., Tinuvin® 152 from BASF SE). Additives insensitive to acid, such as Tinuvin® 152, are advantageous here.

UV stabilizers are used typically in amounts of 0.1% to 5.0% by weight, based on the solid components present in the preparation.

Suitable thickeners include, in addition to free-radically (co)polymerized (co)polymers, typical organic and inorganic thickeners such as hydroxymethylcellulose or bentonite.

Chelating agents which can be used include, for example, ethylenediamineacetic acid and salts thereof and also β-diketones.

Pigments in the true sense are, according to CD Römpp Chemie Lexikon—Version 1.0, Stuttgart/New York: Georg Thieme Verlag 1995, with reference to DIN 55943, particulate “colorants that are organic or inorganic, chromatic or achromatic and are virtually insoluble in the application medium”.

Virtually insoluble here means a solubility at 25° C. below 1 g/1000 g application medium, preferably below 0.5, more preferably below 0.25, very particularly preferably below 0.1, and in particular below 0.05 g/1000 g application medium.

Examples of pigments in the true sense comprise any desired systems of absorption pigments and/or effect pigments, preferably absorption pigments. There are no restrictions whatsoever on the number and selection of the pigment components. They may be adapted as desired to the particular requirements, such as the desired perceived color, for example, as described in step a), for example. It is possible for example for the basis to be all the pigment components of a standardized mixer system.

Effect pigments are all pigments which exhibit a platelet-shaped construction and give a specific decorative color effect. Examples of such effect pigments are pure metallic pigments, such as aluminum, iron or copper pigments; interference pigments, such as titanium dioxide-coated mica, iron oxide-coated mica, mixed oxide-coated mica (e.g., with titanium dioxide and Fe₂O₃ or titanium dioxide and Cr₂O₃), metal oxide-coated aluminum; or liquid-crystal pigments, for example.

The coloring absorption pigments are, for example, organic or inorganic absorption pigments. Examples of organic absorption pigments are azo pigments, phthalocyanine pigments, quinacridone pigments, and pyrrolopyrrole pigments. Examples of inorganic absorption pigments are iron oxide pigments, titanium dioxide, and carbon black.

Dyes are likewise colorants, and differ from the pigments in their solubility in the application medium; i.e., they have a solubility at 25° C. of more than 1 g/1000 g in the application medium.

Examples of dyes are azo, azine, anthraquinone, acridine, cyanine, oxazine, polymethine, thiazine, and triarylmethane dyes. These dyes may find application as basic or cationic dyes, mordant dyes, direct dyes, disperse dyes, development dyes, vat dyes, metal complex dyes, reactive dyes, acid dyes, sulfur dyes, coupling dyes or substantive dyes.

Coloristically inert fillers are all substances/compounds which on the one hand are coloristically inactive and are capable of influencing the orientation (parallel alignment) of the effect pigments. Inert substances/compounds which can be used are given by way of example below, but without restricting the concept of coloristically inert, topology-influencing fillers to these examples. Suitable inert fillers meeting the definition may be, for example, transparent or semitransparent fillers or pigments, such as silica gels, blanc fixe, kieselguhr, talc, calcium carbonates, kaolin, barium sulfate, magnesium silicate, aluminum silicate, crystalline silicon dioxide, amorphous silica, aluminum oxide, microspheres or hollow microspheres made, for example, of glass, ceramic or polymers, with sizes of 0.1-50 μm, for example. Additionally as inert fillers it is possible to employ any desired solid inert organic particles, such as urea-formaldehyde condensates, micronized polyolefin wax and micronized amide wax, for example. The inert fillers can in each case also be used in a mixture.

Preferred fillers comprise silicates, examples being silicates obtainable by hydrolysis of silicon tetrachloride, such as Aerosil® from Degussa, siliceous earth, talc, aluminum silicates, magnesium silicates, calcium carbonates, etc.

Examples of formulation additives are CHIMASSORB 2020 FDL, CHIMASSORB 81, CHIMASSORB 944 FDL, CHIMASSORB 944 LD, IRGAFOS 126, IRGAFOS 126, IRGAFOS 168, IRGAFOS 168 FF, IRGANOX 1010, IRGANOX 1010 FF, IRGANOX 1035, IRGANOX 1035 FF, IRGANOX 1076, IRGANOX 1076 FD, IRGANOX 1098, IRGANOX 1135, IRGANOX 1330, IRGANOX 1520 L, IRGANOX 1726, IRGANOX 245, IRGANOX 245 DW, IRGANOX 5057, IRGANOX 565, IRGANOX B 1171, IRGANOX B 215, IRGANOX B 225, IRGANOX B 225 FF, IRGANOX B 561 FF, IRGANOX B 900, IRGANOX E 201, IRGANOX MD 1024, IRGANOX PS 800 FL, IRGANOX PS 802 FL, IRGASTAB FS 301 FF, IRGASTAB PLUS 5170, IRGASTAB PLUS 5193, IRGASTAB UV 22, LIGNOSTAB 1198, LIGNOSTAB 530, PROSTAB 5198, TINOPAL NFW10 LIQUID, TINOPAL OB CO, TINOPAL SFP, TINUVIN 111 FDL, TINUVIN 1130, TINUVIN 123, TINUVIN 123-DW (N) or ECO, TINUVIN 144, TINUVIN 152, TINUVIN 1577 ED, TINUVIN 171, TINUVIN 249, TINUVIN 249-DW (N) or ECO, TINUVIN 292, TINUVIN 292 HP, TINUVIN 326, TINUVIN 329, TINUVIN 384-2, TINUVIN 400, TINUVIN 400-DW (N) or ECO, TINUVIN 405, TINUVIN 460, TINUVIN 477, TINUVIN 477-DW (N) or ECO, TINUVIN 479, TINUVIN 479-DW (N) or ECO, TINUVIN 5050, TINUVIN 5060, TINUVIN 5100, TINUVIN 5151, TINUVIN 5158, TINUVIN 520, TINUVIN 5248, TINUVIN 5251, TINUVIN 5333-DW (N) or ECO, TINUVIN 5341, TINUVIN 5350, TINUVIN 5460, TINUVIN 5866, TINUVIN 622 SF, TINUVIN 770 DF, TINUVIN 791 FB, TINUVIN 900, TINUVIN 928, TINUVIN 970, TINUVIN 99, TINUVIN 99-2, TINUVIN 9945-DW (N) or ECO, TINUVIN B 75, TINUVIN B 75, TINUVIN CARBOPROTECT, TINUVIN P, TINUVIN PS, TINUVIN PUR 866.

Other examples of formulation additives include products sold under the Tradenames of Dispex, Efka, Rheovis, Hydropalat, Foamaster, Foamstar, Hydropalat, Loxanol, Lignostab, Tinuvin.

Formulation additives may be Dispex® Ultra FA, Dispex® Ultra FA, Dispex® AA, Dispex® CX, Dispex® Ultra PA, Dispex® Ultra PX, Efka® FA, Efka® FA, Efka® PA, Efka® PU, Efka® PX, Dispex® AA 4040, Dispex® AA, Dispex® AA 4140, Dispex® AA 4145, Dispex® CX 4231, Dispex® CX 4234, Dispex® CX 4240, Dispex® CX 4320, Dispex® CX 4340, Dispex® CX 4345, Dispex® HIDE AA 4545, Dispex® HIDE CX 4540, Dispex® HIDE CX 4542 Dispex® Ultra FA 4404, Dispex® Ultra FA 4416, Dispex® Ultra FA 4420, Dispex® Ultra FA 4425, Dispex® Ultra FA 4430, Dispex® Ultra FA 4431 Dispex® Ultra FA 4437 Dispex® Ultra FA 4480, Dispex® Ultra FA 4483, Dispex® Ultra FA 4484, Dispex® Ultra FA 4488, Efka® FA 4600, Efka® FA 4601, Efka® FA 4608, Efka® FA 4609, Efka® FA, Efka® FA 4611, Efka® FA 4620, Efka® FA 4644, Efka® FA 4654, Efka® FA 4663, Efka® FA 4665, Efka® FA 4666, Efka® FA 4671, Efka® FA 4672, Efka® FA 4673, Efka® WE 3110, Dispex® Ultra PA. Dispex® Ultra PA 4550, Dispex® Ultra PA 4560, Dispex® Ultra PX 4275, Dispex® Ultra PX, Dispex® Ultra PX, Dispex® Ultra PX 4585, Efka® PA 4401, Efka® PA 4403, Efka® PA 4404, Efka® PA 4450, Efka® PU 4009, Efka® PU 4010, Efka® PU 4015, Efka® PU 4020, Efka® PU 4046. Efka® PU 4047, Efka® PU 4050, Efka® PU 4061, Efka® PU 4063, Efka® PU 4080, Efka® PX 4300, Efka® PX 4310, Efka® PX 4330, Efka® PX 4340, Efka® PX 4350, Efka® PX 4701, Efka® PX 4703, Efka® PX, Efka® PX, Efka® PX 4780, Efka® PX 4787, Dispex® Ultra PA 4503, Dispex® AA 4040 Ammonium polyacrylate (co-)polymer, Dispex® AA 4135 Sodium polyacrylate, Dispex® AA 4140 Sodium polyacrylate, Dispex® AA 4145 Sodium polyacrylate, Dispex® CX 4231 Ammonium polyacrylate (co-)polymer, Dispex® CX 4234 Styrene-acrylic copolymer, Dispex® CX 4240 Ammonium polyacrylate (co-)polymer, Dispex® CX 4248 Ammonium polyacrylate (co)polymer, Dispex® CX 4320 Sodium salt of carboxylic acid copolymer, Dispex® CX 4340 Sodium polyacrylate (co-)polymer, Dispex® CX 4345 Sodium salt of carboxylic acid copolymer Dispex® HIDE AA 4545, Dispex® HIDE CX 4540, Dispex® HIDE CX 4542, Dispex® Ultra FA 4404, Dispex® Ultra FA 4416, Dispex® Ultra FA 4420, Dispex® Ultra FA 4425, Dispex® Ultra FA 4430, Dispex® Ultra FA 4431, Dispex® Ultra FA 4437 Modified natural oil, Dispex® Ultra FA 4480 Modified fatty alcohol ethoxylate, Dispex® Ultra FA 4483 Phosphoric acid ester, Dispex® Ultra FA 4484 Phosphoric acid ester, sodium salt, Dispex® Ultra FA 4488 Alkylpolyalkoxylate, Efka® FA 4600 Surface active anionic compounds, Efka® FA 4601 Blend of fatty alcohol sulfates, Efka® FA 4608, Efka® FA 4609 Solution of a copolymer with acidic groups, Efka® FA 4610 Acidic polyester polyamide, Efka® FA 4611 Copolymer with acidic groups, Efka® FA 4620 Acidic polyether, Efka® FA 4644 Unsaturated polyamide and acid ester salts, Efka® FA 4654 Carboxylic acid salts, Efka® FA 4663 Salts of a polycarboxylic acid, Efka® FA 4665, Unsaturated carboxylic acid, combined with a compatible organically modified polysiloxane, Efka® FA 4666 Unsaturated carboxylic acid, Efka® FA 4671 Alkylol ammonium salt of carboxylic acid, Efka® FA 4672 Mixture of ionic and non-ionic esters Efka® FA 4673 Anionic aliphatic ester, Efka® WE 3110 Ethoxylated long chain alcohol in water High molecular weight dispersing agents, Dispex® Ultra PA 4530 Modified polyacrylate polymer, Dispex® Ultra PA 4550 Modified polyacrylate polymer, Dispex® Ultra PA 4560 Modified polyacrylate polymer, Dispex® Ultra PX 4275 Copolymer, Dispex® Ultra PX 4290 Copolymer, Dispex® Ultra PX 4522 Non-ionic polymer, Dispex® Ultra PX 4525 Blend of amine- and acid-functional polymers, Dispex® Ultra PX 4575 Acrylic block copolymer made by controlled free radical polymerization (CFRP), Dispex® Ultra PX 4585, Acrylic block copolymer made by controlled free radical polymerization (CFRP), Efka® PA 4401 Modified polyacrylate polymer, Efka® PA 4403 Modified polyacrylate polymer, Efka® PA 4404 Modified polyacrylate polymer, Efka® PA 4450 Carboxy-functional polymer, Efka® PU 4009 Modified polyurethane polymer, Efka® PU 4010 Modified polyurethane polymer, Efka® PU 4015 Modified polyurethane polymer, Efka® PU 4020 Modified polyurethane polymer, Efka® PU 4046 Modified polyurethane polymer, Efka® PU 4047 Modified polyurethane polymer, Efka® PU 4050 Modified polyurethane polymer, Efka® PU 4061 Modified polyurethane polymer, Efka® PU 4063 Modified polyurethane polymer, Efka® PU 4080 Modified polyurethane polymer, Efka® PX 4300Acrylic block copolymer made by controlled free radical polymerization (CFRP), Efka® PX 4310 Acrylic block copolymer made by controlled free radical polymerization (CFRP), Efka® PX 4330 Acrylic block copolymer made by controlled free radical polymerization (CFRP), Efka® PX 4340 Acrylic block copolymer made by controlled free radical polymerization (CFRP), Efka® PX 4350 Acrylic block copolymer made by controlled free radical polymerization (CFRP), Efka® PX 4701 Acrylic block copolymer made by controlled free radical polymerization (CFRP), Efka® PX 4703 Acrylic block copolymer made by controlled free radical polymerization (CFRP), Efka® PX 4733 Advanced polymer, Efka® PX 4753 Advanced polymer, Efka® PX 4780 Advanced polymer, Efka® PX 4787 Advanced polymer, Dispex® Ultra PA 4503 Fatty-acid-modified polymer.

Preferably the formulation additives according to the invention are used in liquid formulations.

In a further aspect disclosed is a system for producing an aqueous polymeric formulation containing said formulation additives associated with a formulation passport or a digital asset.

The chemical production network may include one or more one or more chemical and/or mechanical process(es). The chemical production network may produce one or more output material(s) through chemical and/or mechanical processing. The chemical production network may include multiple types of production processes for producing one or more output material(s) from one or more input material(s). The chemical production network may produce one or more output material(s) from input material(s) provided to the chemical production network. The chemical production network may include a complex production network producing multiple chemical products via multiple production process(es). The chemical production network may include connected, interconnected and/or non-connected production process(es). The chemical production network may include a composite or Verbund network.

The chemical production network may include identity preserving or segregated production process(es). Identity preserving or segregated in this context may refer to environmental attribute(s) of input material(s) being preserved or segregated in the production process(es). Examples are non-fossil, e.g. renewable or recycled, input materials used to produce the one or more formulation additive (s) without fossil content. further examples are fossil input material(s) used to produce the one or more formulation additive (s) with fossil content. Chemical production networks may include non-identity preserving or non-segregated production process(es). Non-identity preserving or non-segregated in this context may refer to non-fossil input material(s) being mixed with fossil input material(s) to produce the formulation additive (s). for example, fossil and renewable input materials may be mixed to produce the formulation additive (s) with fossil and renewable content.

The chemical production network may include one or more production process(es) with multiple production steps. The production steps included in the chemical network may be defined by the physical system boundary of the chemical production network. The system boundary may be defined by location and/or control over production processes or steps. The system boundary may be defined by a site of the chemical production network. The system boundary may be defined by production process(es) or step(s) controlled by one entity or multiple entities jointly. The system boundary may be defined by the value chain with staggered production process(es) or step(s) to the chemical end product, which may be controlled by multiple entities jointly or separately. The chemical production network may include a waste collection, a sorting step, a recycling step such as pyrolysis, a cracking step such as steam cracking, a separation step to separate intermediates of one process step and further processing steps to convert such intermediates to output material(s), in particular formulation additive (s) leaving the system boundary of the chemical production network. The input material(s) may enter the physical system boundary of the chemical production network. The entry point(s) of the chemical production network may be marked by the entry of input material(s) to the chemical production network or the system boundary of the chemical network. The output material(s), in particular formulation additive (s) may leave the physical system boundary of the chemical production network. The exit point(s) of the chemical production network may be marked by the exit of output material(s), in particular formulation additive (s) from the chemical production network or the system boundary of the chemical network.

The chemical production network may include one or more production chain(s) for the production of formulation additive. The production chain(s) for the production of formulation additive may be interconnected. The production chain(s) for the production of formulation additive may be interconnected with production chain(s) for the production of other output material(s). The production chain(s) for the production of formulation additive may include production chain(s) for the production of intermediates used to produce formulation additive. The production chain(s) for the production of formulation additive may use input material(s) provided by chemical network(s) for the production of intermediates usable to produce formulation additive.

One or more input material(s) may be provided to the chemical production network for producing one or more output material(s), in particular formulation additive (s). The output material(s), in particular formulation additive (s) may be produced from one or more input material(s) through one or more chemical process(s) of the chemical production network. The input material may comprise any input material entering the chemical production network at any entry point. The input material may include an output material(s), in particular formulation additive (s) such as a natural, organic or inorganic output material(s), in particular formulation additive (s). The input material may be a pre-cursor product, an intermediate material, a feedstock or a raw material used to produce one or more output material(s), in particular formulation additive (s). The input material may be fed to the chemical production network to produce one or more output material(s), in particular formulation additive (s). The input material may be fed to chemical production network including one or more production process(es) with multiple process steps. The input material may be fed to the chemical production network at the start of the production process or at any intermediate stage of the production process. The input materials entering the chemical production network may be used to produce one or more output material(s), in particular formulation additive (s).

The input material may be associated with an input material identifier. The input material identifier may comprise any identifier uniquely associated with the input material. The input material identifier may be associated with the physical entity of the input material. The input material identifier may be associated with a single batch of input material. The input material identifier may be associated with a group of input materials. The identifier may be associated with multiple physical entities of the input material. The input material identifier may be associated with continuous or semi-continuous stream of input material. The input material identifier may be associated with a stream of the input material e.g. over a certain time period or from a certain supplier. The input material identifier may be linked or connected to one or more environmental attribute(s).

Environmental attribute may refer to a property related to the environmental impact. Such property may be the property of input material(s), chemical process(es), chemical production network(s) and/or formulation additive (s). The environmental attribute may indicate an environmental performance of input material(s), chemical process(es), chemical production network(s) and/or formulation additive (s). The environmental attribute may be derived from properties of input material(s), chemical process(es), chemical production network(s) and/or formulation additive (s). The environmental attribute may be associated with the environmental impact of input material(s), chemical process(es), chemical production network(s) and/or formulation additive (s) at any stage of the lifecycle of the formulation additive (s). The stages may include providing raw material, providing feedstock, producing chemical products, such as intermediate products or end products, producing discrete products by using the chemical products, using chemical products or discrete products, treating end-of-life products, recycling end-of-life products, disposing end-of-life products, reusing components from end-of-life products or any subset of stages. The environmental attribute may be specified or may be derived from any activity of one or more entities participating at any stage of the lifecycle of one or more material(s) or product(s).

The environmental attribute may include one or more characteristic(s) that are attributable to environmental impact of input material(s), chemical process(es), chemical production network(s) and/or formulation additive (s). The environmental attribute may include environmental, technical, recyclability or circularity characteristics(s) associated with the environmental impact of input material(s), chemical process(es), chemical production network(s) and/or formulation additive (s).

The environmental attribute may include one or more characteristic(s) that are attributable to the environmental impact of input material(s), chemical process(es), chemical production network(s) and/or formulation additive (s). The environmental attribute may include environmental, technical, recyclability, safety, legal, or circularity characteristics(s), preferably environmental, technical, recyclability, circularity characteristics(s) associated with the environmental impact of input material(s), chemical process(es), chemical production network(s) and/or formulation additive (s). The one or more environmental attribute(s) may be attributable to the environmental impact of the formulation additive. The one or more environmental attribute(s) may relate to environmental, technical, recyclability, circularity and/or complementary risk characteristic(s) of the formulation additive.

Environmental characteristic(s) may specify or quantify ecological or compositional criteria associated with environmental impact. Environmental characteristic(s) may be or may be derived from measurements taken during the lifecycle. Environmental characteristics may be determined at any stage of the lifecycle and may characterize the environmental impact for such stage or up to such stage. Environmental characteristic(s) may for example include carbon footprint, greenhouse gas emissions, resource usage, air emissions, ozone depletion potential, water pollution, noise pollution, energy consumption, waste reduction, or eutrophication potential. Environmental characteristic(s) may for example include product characteristics like compositions, impurity profiles, or information on substances of concern as defined by industry specific regulatory or value chain requirements or product characteristics related to the production of the product like bio based, vegetable based, animal based, halogen-free, fluorine-free, vegan, halal, kosher, palm oil-free, natural, tox-fee, volatile organic compounds-free or any combinations thereof. Preferably environmental characteristic(s) include product characteristics related to the production of the product like bio based, vegetable based, animal based, halogen-free, fluorine-free, vegan, halal, kosher, palm oil-free, natural, tox-fee, volatile organic compounds-free or any combinations thereof.

Technical characteristic(s) may specify or quantify performance at least indirectly associated with the environmental impact. Technical characteristic(s) may be or may be derived from measurements taken during the lifecycle. Technical characteristics may be determined at any stage of the lifecycle and may characterize the performance for such stage or up to such stage. Technical characteristic(s) may for example include chemical composition data, raw material composition such as bio-based or recycled input material content specifying e.g. x % non fossil and y % fossil content, bill of materials, product specification data such as product purity, product form (as indication to their impact on dust formation/release), safety data, product extractability, migration data, toxicological data or ecotoxicological data, product component data, safety data, application property data, application instructions, quality data or any combinations thereof.

Circularity characteristic(s) may specify or quantify the life cycle characteristics associated with circular uses. Circularity characteristic(s) may be or may be derived from measurements taken during the lifecycle. Circularity characteristic(s) may be or may be derived from circular data recorded in one or more prior lifecycle(s) including reuse. Circularity characteristic(s) may be determined at any stage of the lifecycle and may characterize the reuse or recycling performance for such stage or up to such stage. Circularity characteristic(s) may for example include recycling data, reuse rate, recycling rate, recycling loops, reuse performance, reused quality or any combinations thereof.

Recyclability characteristic(s) may specify or quantify life cycle characteristics associated with recycling uses. Recyclability characteristic(s) may include the composition of the material including specifically tailored constituents making the material suitable for recycling. Recyclability characteristic(s) may be or may be derived from measurements taken during the lifecycle. Recyclability characteristic(s) may be or may be derived from recycling data recorded in one or more prior lifecycle(s). Recyclability characteristics may be determined at any stage of the lifecycle and may characterize the recycling performance for such stage or up to such stage. Recyclability characteristic(s) may for example include recycling data, number of reuses, recyclate composition, recyclate quality, waste stream composition, waste stream quality or any combinations thereof.

Environmental impact may for example include impacts on the safe use and application and compliance with mandatory and/or voluntary assessment schemes needed for the application or required by the value chain in which the product itself, formulation of said product and conversion products of said products are handled.

In one embodiment the formulation additive passport or digital asset of the formulation additive may include mass balanced environmental attributes related to the input material. Mass balanced environmental attributes may include environmental attributes of the input material(s) used to produce the formulation additive, which are tracked and by mass attributable to the formulation additive. The environmental impact of input material(s) may be determined based on input material(s) used in the chemical process(s) to produce the formulation additive. for example, bio-based, renewable and/or recycled content of input material(s) used to produce the formulation additive may be tracked. further for example, castor oil or palm oil content of input material(s) used to produce the formulation additive may be tracked. further for example, properties related to the environmental impact of the input material include RSPO palm oil, palm oil free or castor oil may be tracked. further for example, properties of the chemical process(es) used to produce the formulation additive may be tracked. Examples of tracked process properties related to the environmental impact include water consumption, CO₂ emissions and/or Greenhouse Gas (GHG) emissions, amount of waste generation, mixed material generation, design for recycling, energy consumption, processing properties such as less waste or less loss of properties. The properties may be tracked based on a certificate from a certifying agency. The properties may be tracked based on inherent physical properties derived from measurements.

In one embodiment the produced formulation additive is connected to the decentral identifier physically identifying the produced formulation additive. The production operating apparatus may be configured to provide the decentral identifier associated with a physical entity of the produced formulation additive. The production operating apparatus may be configured to link the decentral identifier to a physical identifier of the produced formulation additive. The production operating apparatus may be configured to assign the decentral identifier to the physical identifier connected to the produced formulation additive.

In one embodiment the decentral identifier relates to data associated with at least one product produced from the formulation additive, wherein the one or more environmental attribute(s) associated with the at least one product is derived from one or more environmental attribute(s) associated with the formulation additive. The one or more environmental attribute(s) associated with the formulation additive may be associated with the one or more input material(s) and/or the chemical process(s) used to produce the formulation additive. The decentral identifier may relate to any identifier uniquely associated with the formulation additive. The decentral identifier may be associated with the physical entity of the formulation additive. The decentral identifier may refer to a single batch of formulation additive. The decentral identifier may be associated with a group of formulation additive. The identifier may refer to multiple physical entities of the formulation additive. The decentral identifier may be associated with continuous or semi-continuous stream of formulation additive. The identifier may refer to a stream of the formulation additive e.g. over a certain time period or from a certain supplier.

In one embodiment the one or more environmental attribute(s) associated with the formulation additive (s) are provided from at least one balancing account configured to store environmental attribute(s) associated with input material(s). An inbound allocator may be configured to allocate the one or more environmental attribute(s) associated with input material(s) to at least one balancing account e.g. on entry of the input material to the chemical production network. The balancing account may be associated with the respective environmental attribute type. An outbound assigner may be configured to assign at least one environmental attribute from the at least one balancing account associated with the respective environmental attribute to the decentral identifier. One or more environmental attribute(s) may be assigned to the at least one decentral identifier. Assignment may include de-allocation of the one or more environmental attributes from the balancing account associated with the respective environmental attribute type. By using the balancing accounts environmental attributes of input materials can be reliably tracked and assigned to formulation additive.

In one embodiment the one or more environmental attribute(s) associated with the formulation additive (s) are provided from at least one balancing account configured to store environmental attribute(s) associated with input material(s). An inbound allocator may be configured to allocate the one or more environmental attribute(s) to at least one balancing account associated with the respective environmental attribute, e.g. on input material entering the chemical production network. The balancing account may be associated with the respective environmental attribute type. The one or more environmental attribute(s) associated with the input materials may be allocated to the balancing account associated with the respective environmental attribute type. An outbound assigner may be configured to assign or link at least one environmental attribute from the at least one balancing account associated with the respective environmental attribute type to the decentral identifier. This may include de-allocation of the one or more environmental attribute(es) from the balancing account associated with the respective environmental attribute type. By using the balancing accounts environmental attributes can be tacked through the chemical production network. This way the environmental attributes may be detached from the material flow. Attribution of environmental attribute(s) may be conducted on a mass balance basis for the chemical production network. In such approach the total mass of input materials and formulation additive as well as the attribution of respective environmental attribute(s) associated with input materials and formulation additive are balanced.

In one embodiment the one or more environmental attribute(s) are associated with at least one property related to the environmental impact of the one or more input material(s) and/or the chemical process(s). The one or more environmental attribute(s) may specify environmental properties of the input material(s) used to produce the formulation additive and/or the one or more environmental attribute(s) may specify environmental properties of the chemical process(es) used to produce the formulation additive. The one or more environmental attribute(s) may be generated from environmental properties of the input material(s) used to produce the formulation additive, process data associated with the chemical processing of the input material(s) and/or energy data associated with the energy consumption of the chemical processing. The one or more environmental attribute(s) may include a recycled content associated with the input material(s) and allocated or allocatable to the formulation additive (s), a renewable content associated with the input material(s) and allocated or allocatable to the formulation additive (s), and/or a product carbon footprint associated with the formulation additive (s).

In one embodiment the production operating apparatus is configured to gather environmental attributes associated with the produced formulation additive before, during and/or after production of the formulation additive by the chemical production network. The environmental attributes associated with the produced formulation additive may relate to input material(s). The environmental attributes associated with input materials may be provided before, during and/or after production of the formulation additive by the chemical production network. The environmental attributes associated with input materials may be allocated to at least one balancing account before, during and/or after production of the formulation additive by the chemical production network. The environmental attributes associated with the produced formulation additive may relate to environmental properties generated from process data associated with the chemical processing of the input material(s) and/or energy data associated with the energy consumption of the chemical processing. The environmental attributes associated with the produced formulation additive may be generated before, during and/or after production of the formulation additive by the chemical production network. The process data associated with the chemical processing of the input material(s) and/or energy data associated with the energy consumption of the chemical processing may be gathered prior, during and/or after production of the formulation additive.

In one embodiment the formulation additive passport or the digital asset include the decentral identifier associated with the formulation additive and the one or more environmental attribute(s) linked to the decentral identifier. The one or more environmental attribute(s) may be linked to the decentral identifier included the formulation additive passport or the digital asset. The one or more environmental attribute(s) may be stored in a data base of the formulation additive producer for access by any formulation additive user. The one or more environmental attribute(s) may be stored in a data base of the formulation additive producer for transfer to a formulation additive user e.g. when accessed or on providing the formulation additive. The decentral identifier may comprise any unique identifier uniquely associated with the formulation additive producer and formulation additive data such as the environmental attributes. The decentral identifier may include a Universally Unique IDentifier (UUID) or a Digital IDentifier (DID). The decentral identifier may be issued by a central or decentral identity issuer. The decentral identifier may be linked to authentication and/or authorization information. Via the decentral identifier and its unique association with the formulation additive producer and formulation additive data, such as the environmental attributes, access to the formulation additive data may be controlled by the formulation additive producer. This contrasts with central authority schemes, where identifiers are provided by such central authority and access to data is controlled by such central authority. Decentral in this context refers to the usage of the identifier in implementation as controlled by the data owner, such as the formulation additive producer.

The decentral identifier may be uniquely associated with the formulation additive or the physical entity of the formulation additive, e.g. as packaged for transportation to the formulation additive user. The decentral identifier may be uniquely to the one or more environmental attribute(s). The formulation additive passport or the digital asset may include one or more digital representation(s) pointing to formulation additive data including the environmental attribute(s) or parts thereof including the environmental attribute(s). The digital representation may comprise at least one interface to a data providing service. It may further include at least one interface to a data consuming service. It may include an endpoint for data exchange or sharing (resource endpoint) or an endpoint for service interaction (service endpoint), that is uniquely identified via a communication protocol. The digital representation(s) pointing to formulation additive data or parts thereof may be uniquely associated with the decentral identifier.

The formulation additive passport or the digital asset may comprise or be connected to a digital representation of formulation additive data, such as environmental attribute(s). The digital representation may include a representation for accessing the formulation additive data, such as environmental attribute(s) or part thereof. The digital representation may include a representation of formulation additive data, such as environmental attribute(s). The formulation additive passport or the digital asset may include or be connected to data related to the formulation additive data, such as environmental attribute(s), the authentication information and the decentral identifier. The data related to the formulation additive data, such as environmental attribute(s)may include the digital representation of the formulation additive data, such as environmental attribute(s).

### BRIEF DESCRIPTION OF THE DRAWINGS

In the following, the present disclosure is further described with reference to the enclosed figures:

FIG. 1 illustrates schematically an example of a chemical production network producing one or more output material(s) from one or more input material(s) in connection with a production operating system including an attribute management system.

FIG. 2 illustrates schematically an example of attributing environmental attributes of input materials to output materials of the chemical production network.

FIG. 3 illustrates schematically an example of attributing environmental attributes of input materials and chemical processes to an output material of the chemical production network.

FIG. 4 illustrates schematically another example of a method or apparatus for providing environmental attributes associated with output materials to a material user as data consumer via a decentral network.

FIG. 5 illustrates schematically an example of a method or apparatus for providing environmental attributes of output materials across value chains via the decentral network.

FIG. 6 illustrates schematically an example of a chemical production network for producing formulation additive associated with the digital asset.

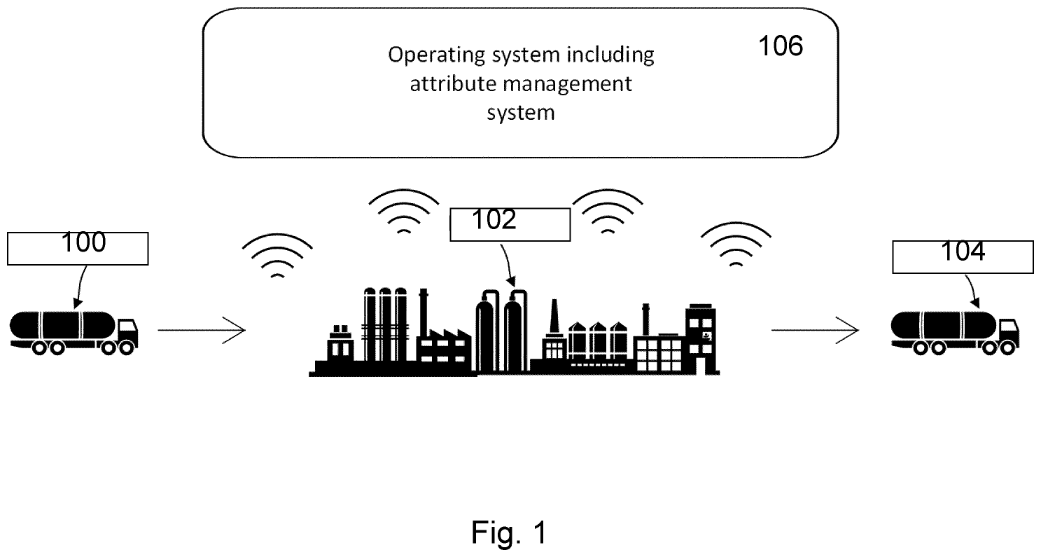

FIG. 1 illustrates an example of a chemical production network 102 producing one or more output material, in particular formulation additive (s) 104 from one or more input material(s) 100 in connection with a production operating system 106 including an attribute management system.

For producing one or more output material(s), in particular formulation additive (s)104 different input materials 100 may be provided as physical inputs to the chemical production network 102.

The physical input and output material(s), in particular formulation additive (s)100, 104 may be associated with one or more properties related to environmental impact. The properties related to environmental impact may be digitalized in the form of environmental attributes such as recycled or bio-based content of the input materials. The production operating system 106 may be configured to ingest such environmental attributes and to track the environmental attributes across the chemical production network 102 from input materials 100 to output material(s), in particular formulation additive (s)104.

The chemical production network 102 may include multiple interlinked processing steps. The chemical production network 102 may be an integrated chemical production network 102 with interrelated production chains. The chemical production network 102 may include multiple different production chains that have at least one intermediate product in common. The chemical production network 102 may include multiple stages of the chemical value chain. The chemical production network 102 may include the producing, refining, processing and/or purification of gas or crude oil. The chemical production network 102 may include a stream cracker, or a syngas plant connected to multiple production chains that output chemical products 104 from the effluent of such plants. The chemical production network 102 may include multiple production chains that output from one or more input material(s) 100 one or more output material(s), in particular formulation additive (s). The chemical production network 102 may include multiple tiers of a chemical value chain. The chemical production network 102 may include a physically interconnected arrangement of production sites. The production sites may be at the same location or at different locations. In the latter case the production sites may be interconnected by means of dedicated transportation systems such as pipelines, supply chain vehicles, like trucks, supply chain ships or other cargo transportation means.

The chemical production network 102 may chemically convert input materials 100 to one or more output material(s), in particular formulation additive (s) 104. The chemical production network 102 may convert input materials 100 by way of chemical conversion to one or more output material(s), in particular formulation additive (s) 104.

The input materials 100 may be fed to the chemical production network 102 at any entry point. The input materials 100 may be fed to the chemical production network 102 at the start of the chemical production network 102. Input materials 100 may for example make up the feedstock of a steam cracker. The input material 100 may include non-fossil input material, such as bio-based or recycled material, and/or fossil input material for the manufacture of chemical intermediates and chemical output material(s), in particular formulation additive (s) 104.

The chemical production network 102 may include multiple production steps. The production steps included in the chemical production network 102 may be defined by the system boundary of the chemical production network 102. The system boundary may be defined by location or control over production processes. The system boundary may be defined by the site of the chemical production network 102. The system boundary may be defined by production processes controlled by one entity or multiple entities jointly. The system boundary may be defined by value chain with staggered production processes to an end product, which may be controlled by multiple entities separately. The chemical production network 102 may include a waste collection and sorting step, a recycling step such as pyrolysis, a cracking step such as steam cracking, a separation step to separate intermediates of one process step and further processing steps to convert such intermediates to output material(s), in particular formulation additive (s) 104 leaving the system boundary of the chemical production network 102.

The production operating system 106 of the chemical production network 102 may be configured to monitor and/or control the chemical production network 102 based on operating parameters of the different processes. One process step monitored and/or controlled may be the feed of input materials 100 or the release of output material(s), in particular formulation additive (s) 104. Another process step monitored and/or controlled may be the registration of environmental attributes associated with input materials 100 entering the system boundary of the chemical production network 102. Yet another process step monitored and/or controlled may be the attribution of environmental attributes to output material(s), in particular formulation additive (s) 104 produced via the chemical production network. Yet another process step monitored and/or controlled may be the management of environmental attributes associated with input materials 100 and output material(s), in particular formulation additive (s) 104 of the chemical production network 102.

The production operating system 106 may be configured to register inbound environmental attributes, to assign outbound environmental attributes. The production operating system 106 may be configured to access data related the inputs materials 100, the processes and/or the output material(s), in particular formulation additive (s) 104 of the chemical production network 102. for example, the production operating system 106 may be configured to register a recycled or bio-based content of the one or more input material(s) 100 used in the chemical production network 102 as environmental attribute. The production operating system 106 may be configured to allocate the environmental attribute to at least one balancing account associated with the recycled or bio-based content of the input materials 100. The production operating system 106 may be configured to allocate at least a part of the environmental attributes from the at least one balancing account to the at least one output material(s), in particular formulation additive (s) 104.

The production operating system 102 may be configured to handle environmental attributes related to the input and output material(s), in particular formulation additive (s) 100/104 of the chemical production network 102. for example, the production operating system 106 may be configured to determine environmental attributes associated with the use of input materials 100 impacting the environmental property of the chemical production network 102 and the output material(s), in particular formulation additive (s) 104 produced by the chemical production network 102. further in particular, the production operating system 102 may be configured to determine environmental attributes associated with the output material(s), in particular formulation additive (s) 104. This way the production operating system 102 may be configured to store environmental attributes in balancing accounts or to delete environmental attributes from the balancing accounts. The environmental attributes may hence be viewed as a credit that may be deposited in an account or deducted from an account related to the input and output material(s), in particular formulation additive (s) of the chemical production network 102. This way the environmental impact of the production may be tracked and/or traced.

In chemical production networks 102 multiple value chains may be linked. Additionally different input materials 100 or chemical processes impacting the environmental property of output material(s), in particular formulation additive (s) 104 produced by the chemical production network 102 may be used. Examples of input materials 100 impacting at least one environmental property of output material(s), in particular formulation additive (s) 104 produced from such input materials 100 are recycled, renewable or bio-based input materials 104. Examples of chemical processes impacting the environmental property include chemical processes using environmentally friendly technology such as carbon capture, carbon utilization or heat pumps.

Owing to the processing of chemicals in continuous or semi-continuous production and the complexity of chemical production networks 102, traceability of the input materials through the network may be hampered. In such scenarios, an equivalent environmental attribute signifying the impact on the environmental property of output material(s), in particular formulation additive (s) 104 produced by the chemical production network may be allocated to balancing accounts 122 and assigned to one or more output material(s), in particular formulation additive (s) 104 of the chemical production network 102. The environmental attributes may hence be decoupled from the physical material flow inside the chemical production network 102. Decoupling may be based on the mass balance model in that the equivalent amount assigned to the one or more output material(s), in particular formulation additive (s) may not exceed the equivalent amount provided by input materials or processes. If an equivalent amount has been allocated to the virtual account of one environmental attribute type, it may not be allocated a second time to another virtual account of the one environmental attribute type. Environmental attribute types may be recycled, bio-based, renewable or the like. Environmental attributes may be provided in the form of digital assets or formulation additive passports attached to the physical entity of the formulation additive.

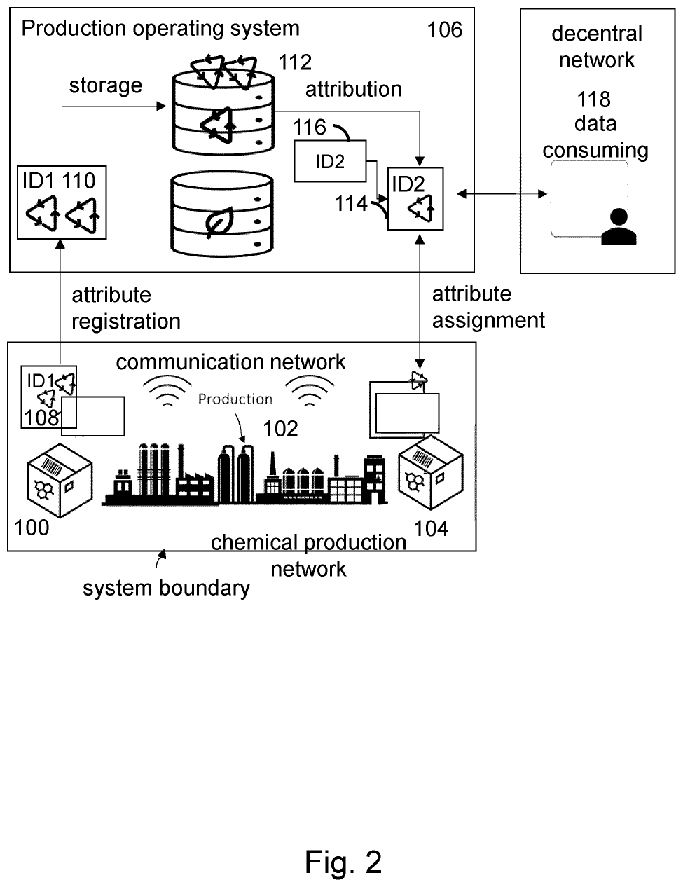

FIG. 2 illustrates schematically an example of attributing environmental attributes associated with input materials 100 to output material(s), in particular formulation additive (s) 104 of the chemical production network 102.

As shown in FIG. 1 the chemical production network 102 and operations of the chemical production network 102 may be monitored and/or controlled by a production operating system 106.

The production operating system 106 may be configured to track environmental attributes from input materials 100 fed to the chemical production network 102 to output material(s), in particular formulation additive (s) 104 produced by the chemical production network 102. for tracking the operating system 106 may be configured to register environmental attributes associated with the input materials 100 provided to the chemical production network 102 and to attribute environmental attributes to output material(s), in particular formulation additive (s) 104 produced by the chemical production network 102.

The input materials 100 such as pyrolysis oil, bio-naphtha or bio-gas may be provided to the chemical production network 102. The input materials 100 may enter the chemical production network at the entry point, such as a such as a steam cracker or a syngas plant. The input materials 100 may be used in the chemical production network 102 to produce one or more output material(s), in particular formulation additive (s) 104 from the input materials 100. output material(s), in particular formulation additive (s) 104 may be provided at exit points of the chemical production network 102. further output material(s) may be compounds containing oxanilide, triazine or benzotriazole structures and derivatives thereof or one of the compounds described under formulation above.

On entry of the input material 100, input material data 108 may be provided via a communication network to a computing interface of the production operating system 106. A data provider, such as a QR code reader, may be configured to provide material data 108 related to the one or more input material(s) 100 and respective environmental attributes 108 to a computing interface configured to allocate the environmental attributes associated with the input materials 100. The material data 108 may include the input material identifier and environmental attributes associated with the input materials 100. The input material identifier may be associated with the physical entity of the input material 100 entering the chemical production network 102. The material data may be provided on, prior or after providing of the one or more input material(s) at entry points to the chemical production network 102.

The input material identifier may be linked to the environmental attribute(s) associated with the respective input material(s) 100, the amount of input material 100 and the certificate certifying the environmental attribute(s). The amount of input material may be a measured amount of input material 100 fed to a plant or storage of the chemical production network 102 for producing one or more output material(s), in particular formulation additive (s) 104 from the input material(s) 100. The input material identifier associated with the respective input material 100, the environmental attribute(s) associated with the respective input material(s) 100 and the amount of input material(s) 100 provided to the chemical production network 102 may be provided to the production operating system 106. Such data may be provided via a communication network on entry to chemical production network 102, or the data may be transferred from a computing system to the production operating system 106.

An inbound allocator 110 may be configured to allocate the one or more environmental attribute(s) to at least one balancing account 112 associated with the respective environmental attribute. For example, one balancing account 112 may relate to environmental attributes from recycled material and another balancing account 112 may relate to environmental attributes from bio-based material. The balancing account may be associated with the respective environmental attribute type, such as bio-based or recycled 100. Based on such association the balancing account associated with the environmental attribute type of the respective input material 100 may be selected. The environmental attributes may be allocated to the selected balancing account. For example, the account 112 for recycled material may be selected and the environmental attribute may be allocated to such account 122.

To allocate, the one or more environmental attribute(s) may be converted to balancing units and the balancing units may be allocated to the balancing account 122. The conversion may be based on a conversion factor such as mass, weight, carbon atoms, hydrogen atoms, methane equivalents or any other suitable measure for quantifying the environmental impact of the environmental attribute. The conversion factor may hence take into account the difference between producing chemical products from conventional input material(s) and producing chemical products from non-conventional input material(s) or producing chemical products from a mix of conventional and non-conventional input materials. The conversion factor may relate to differences in chemical and/or physical properties of conventional and non-conventional input material(s).

By using the balancing accounts 112 it can be ensured that environmental attributes of input materials 100 are only used once for assignment to formulation additive 104. This way double counting on input or output is avoided to ensure positive environmental impact can be reliable tracked and assigned to formulation additive 104.

An identifier provider 116 may be configured to provide the formulation additive identifier associated with the formulation additive produced by the chemical production network 102 and provided at the exit point from the chemical production network 102.

An outbound assigner 114 may be configured to assign at least one environmental attribute from the at least one balancing account 112 associated with the respective environmental attribute to the formulation additive identifier ID2. One or more environmental attribute(s) may be assigned to the at least one formulation additive identifier ID2. Assignment may include de-allocation of the one or more environmental attributes from the balancing account 112 associated with the respective environmental attribute type. Assignment may include converting one or more balancing unit(s) to one or more environmental attribute(s).

Assigning at least one environmental attribute associated with input material(s) to formulation additive (s) may include the linking of the formulation additive identifier ID2 with the environmental attribute. The formulation additive identifier ID2 may be associated with the physical entity of the formulation additive. This way the virtual identifier of a material may be uniquely linked to the physical material. Such linking may include a physical or virtual link of identifiers uniquely associated with the physical material. For physical linking a tag or code may be physically connected to the material, e.g., by printing a QR code on the packaging. For virtual linking different identifiers associated with the physical material may be linked. For example, an order number, a batch number, LOT number or a combination thereof may be linked.

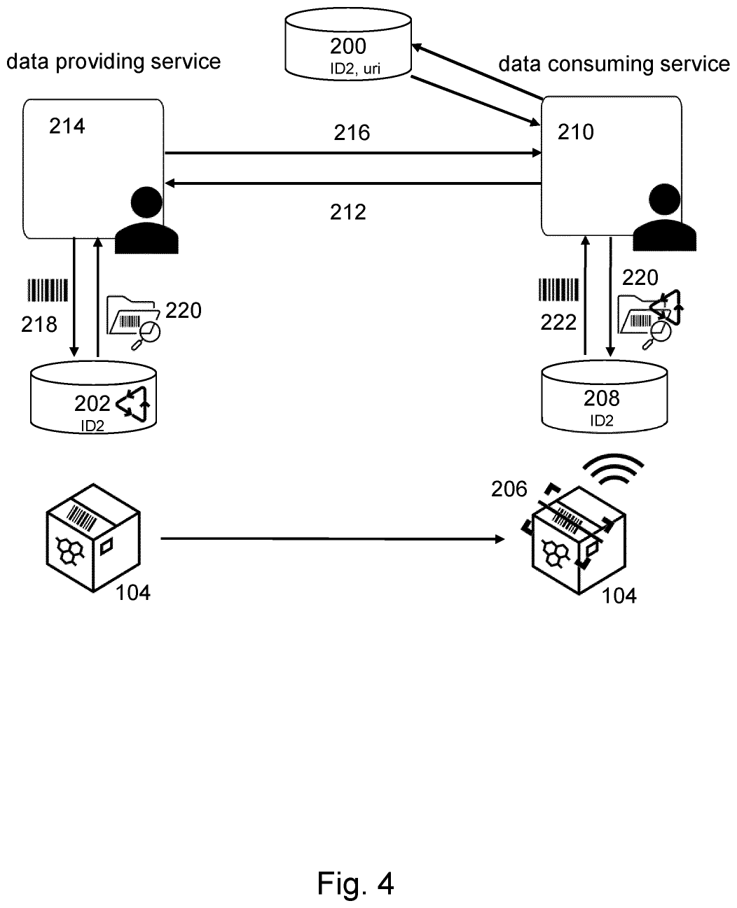

The outbound assigner 114 may be configured to provide the environmental attributes associated with the formulation additive to a data consumer, such as a system associated with a user of the formulation additive. The outbound assigner 114 may be configured to provide the environmental attributes associated with the formulation additive to a decentral network as will be described in the example of FIG. 4. Environmental attributes may be provided via the above ID based schema in the form of digital assets or formulation additive passports associated with the physical entity of the formulation additive.

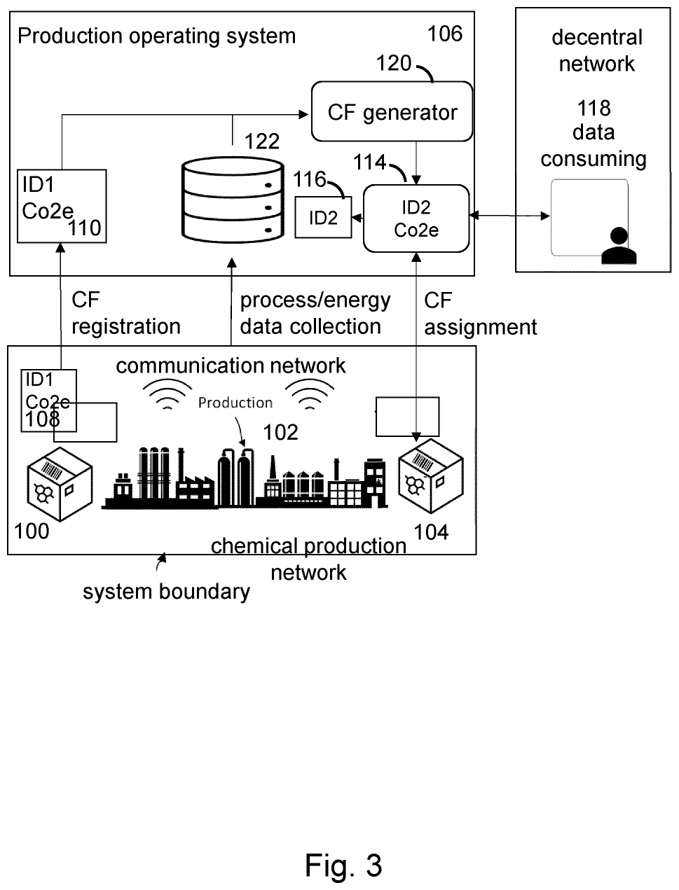

FIG. 3 illustrates schematically an example of attributing environmental attributes of input materials 100 and chemical processes to the formulation additive 104 of the chemical production network 102.

As described in the context of FIGS. 1 and 2 the chemical production network 102 and operations of the chemical production network 102 may be monitored and/or controlled by a production operating system 106. Input materials 100 such as pyrolysis oil, bio-naphtha or bio-gas may be provided to the chemical production network 102. The input materials 100 may be used in the chemical production network 102 to produce one or more formulation additive (s) 104 from the input materials 100.

On entry of the input material 100, input material data 108 may be provided via a communication network to a computing interface of the production operating system 106. A data provider, such as a QR code reader, may be configured to provide material data 108 related to the one or more input material(s) 100 and respective environmental attributes 108 to a computing interface configured to allocate the environmental attributes associated with the input materials 100. The material data 108 may include the input material identifier and environmental attributes associated with the input materials 100. The input material identifier may be associated with the physical entity of the input material 100 entering the chemical production network 102. The input material identifier may be linked to the carbon footprint of the input material 100 as environmental attribute. The material data may be provided on, prior or after providing of the one or more input material(s) at entry points to the chemical production network 102.

The inbound allocator 110 may be configured to retrieve the one or more environmental attribute(s) and to provide such attributes to the carbon footprint (CF) generator 120. A process data provider 122 may be configured to gather process data associated with the chemical processing of the input material(s) 100 to produce the formulation additive (s) 104. The process data provider 122 may be configured to gather energy data associated with the energy consumption of the chemical processing. The process data provider 122 may be configured to provide the process data and the energy data to the CF generator 120.

The CF generator 120 may be configured to determine the carbon footprint of the formulation additive produced by the chemical production network. The carbon footprint of the of the formulation additive may be determined based on the process data, the energy data and the carbon footprint of the input material(s) 100 used to produce the formulation additive.

An identifier provider 116 may be configured to provide the formulation additive identifier associated with the formulation additive produced by the chemical production network 102 and provided at the exit point from the chemical production network 102.

An outbound assigner 114 may be configured to assign the determined carbon footprint to the formulation additive identifier ID2. One or more environmental attribute(s) may be assigned to the at least one formulation additive identifier ID2, such as described in the context of FIG. 2.

The outbound assigner 114 may be configured to provide the environmental attributes, in particular the carbon footprint, associated with the formulation additive to a data consumer, such as a system associated with a user of the formulation additive. The outbound assigner 114 may be configured to provide the environmental attributes associated with the formulation additive to a decentral network as will be described in the example of FIG. 4. Environmental attributes may be provided via the above ID based schema in the form of digital assets or formulation additive passports associated with the physical entity of the formulation additive.

FIG. 4 illustrates schematically an example of a method or apparatus for providing environmental attributes associated with formulation additive to a material user as data consumer via a decentral network.

The formulation additive 104 as produced by the chemical production network 102 may be provided in association with the digital asset as described in the context of FIGS. 2 and 3. The digital asset may include the formulation additive identifier. The digital asset may include one or more environmental attribute(s) such as the product carbon footprint, recycled content or bio-based content. The digital asset may relate to one or more environmental attribute(s) such as the product carbon footprint, recycled content or bio-based content. The digital asset may include a digital representation of one or more environmental attribute(s) such as the product carbon footprint, recycled content or bio-based content.

The digital asset may further include or relate to authentication and/or authorization information linked to the formulation additive identifier. The authentication and/or authorization information may be provided for authentication and/or authorization of a data provider 208 and/or data consumer 210. The formulation additive identifier may include or relate to a decentral identifier, that is uniquely associated with the formulation additive. The decentral identifier may be connected to the digital representation of the environmental attributes. The digital representation may include a representation for accessing the environmental attributes or parts thereof. The decentral identifier may include a Universally Unique IDentifier (UUID) or a Digital IDentifier (DID). The decentral identifier may include any unique identifier uniquely associated with a data owner and/or formulation additive. The data owner may be the producer of the formulation additive. Via the decentral identifier and its unique association with the data owner and/or formulation additive access to the material configuration data may be controlled by the data owner.

The digital asset including the digital representation of one or more environmental attribute(s) such as the product carbon footprint, recycled content or bio-based content may be stored in a decentral data base 200. The one or more environmental attribute(s) such as the product carbon footprint, recycled content or bio-based content may be stored in a data base 202 associated with the data owner, such as the producer of the formulation additive 104.

The formulation additive 104 may be physically delivered to a user of the formulation additive. The formulation additive may be connected with a QR-code having encoded the formulation additive identifier. The user of the formulation additive may read the QR-code through a QR-code reader 206. The formulation additive identifier may be provided to a data base 208 associated with the user of the formulation additive 104. In other embodiments the user of the formulation additive may retrieve the formulation additive identifier through the decentral data base 200.

The data owner in this example may be the input material producer, the output material producer, the output material user, the end product producer. The data owner may comprise any entity generating data. The data generating node may be coupled to the data owner or the entity owning or producing physical products from or for which data is generated. The data may be generated by a third-party entity on behalf of the entity owning physical products from or for which data is generated.

The data consuming service may comprise computer-executable instructions for accessing and/or processing data, such as formulation additive data, associated with the data owner. The data providing service may comprise computer-executable instructions for providing and/or processing data, such as formulation additive data, associated with the data owner for accessing and/or processing by the data consuming service.

Based on the received formulation additive identifier a request to access the environmental attributes associated with the formulation additive identifier may be triggered by the data consuming service 210 as signified by arrow 212. The formulation additive identifier may be provided to the data providing service 214 of the producer of the formulation additive 104. In addition, authentication and/or authorization information may be provided.

The request may be authenticated and/or authorized to access the environmental attributes associated with the formulation additive identifier. Based on successful authorization and/or authentication access to the environmental attributes associated with the formulation additive identifier may be granted.

For access the formulation additive identifier may be provided to the data providing service 214 as signified by arrow 212. The data providing service 214 may use the received formulation additive identifier to retrieve the environmental attributes associated with the formulation additive 104 as signified by arrows 218 and 220. The environmental attributes associated with the formulation additive 104 provided to the data providing service 214 may be provided to the data consuming service 210 as signified by arrow 216. The environmental attributes associated with the formulation additive 104 may be stored in the data base 208 associated with the user of the formulation additive 104 as signified by arrow 220.

Through the output identifier or decentral identifier, the environmental attributes can be uniquely associated with the formulation additive. Through the decentral network the environmental attributes may be transferred between the producer of the formulation additive and the user of the formulation additive. This way the environmental attributes can be shared with unique association to the formulation additive and without central intermediary directly between the value chain players. This allows for transparency of environmental attributes across the value chain and positive environmental impacts from formulation additive of the chemical production network can be tracked through the value chain.

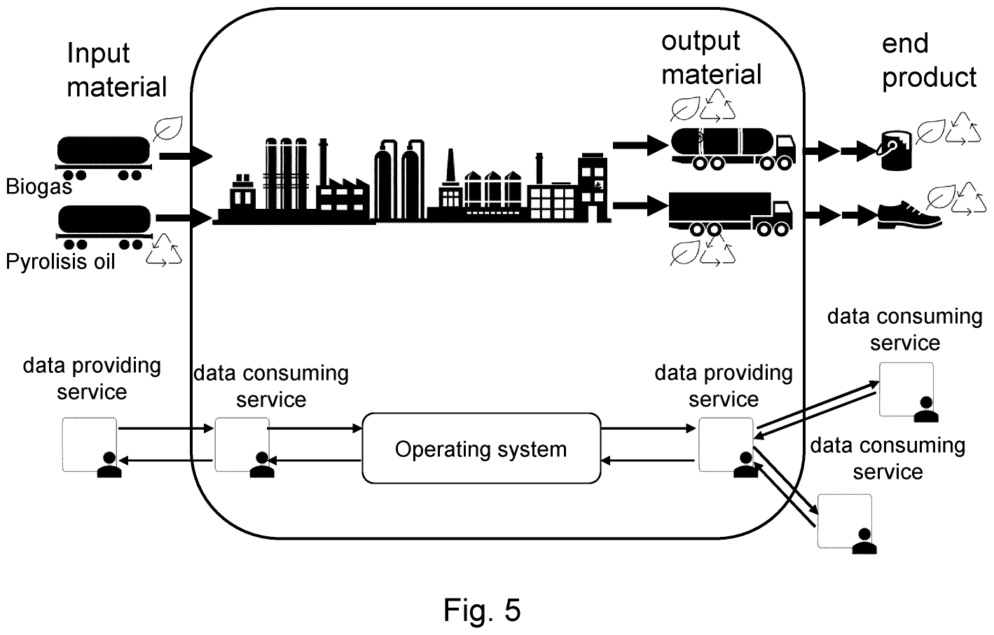

FIG. 5 illustrates schematically an example of a method or apparatus for providing environmental attributes associated with formulation additive across value chains via the decentral network.

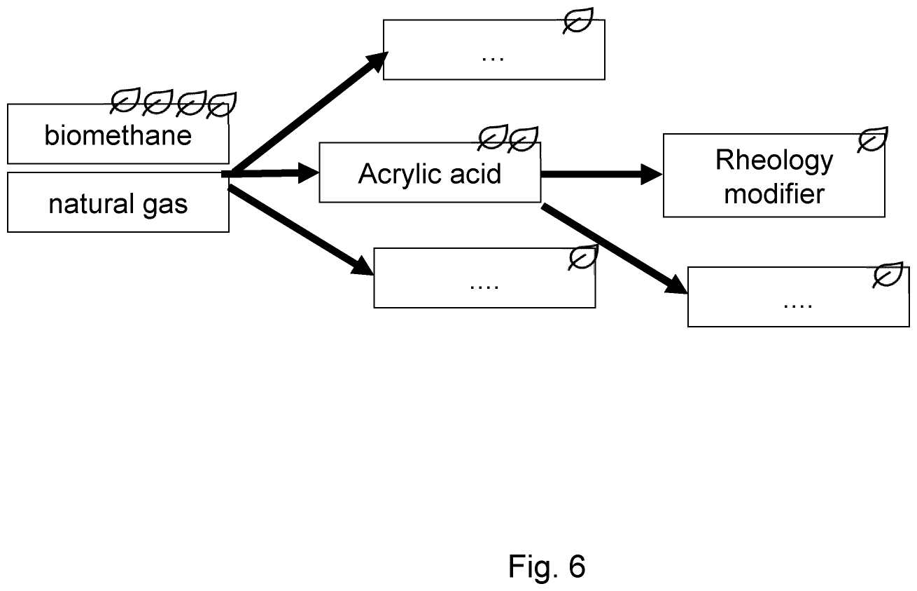

In the example of FIG. 6 a fully connected value chain including the chemical production network is illustrated. In the example, the input material provider, the formulation additive producer, the formulation additive user and the end product producer may be connected to the decentral network as described in the context of FIG. 4. Environmental attributes may be provided via the ID based schema described in the context of FIGS. 2-5 in the form of digital assets or formulation additive passports associated with the physical entity of the input material, the formulation additive, any intermediate product or the end product.

The input material provider may provide the input materials such as bio-gas or pyrolysis oil. The environmental attributes of the input material may be provided through the data providing service connected to the decentral network as described in the context of FIG. 4. The formulation additive producer may produce the formulation additive from the input material(s) provided to the chemical production network. The formulation additive producer may access the environmental attributes associated with the input material through a data consuming service connected to the decentral network as described in the context of FIG. 4. The formulation additive producer may manage the environmental attributes via the production operating system as described in the context of FIGS. 1 to 3. The formulation additive producer may assign the environmental attributes associated with the input materials or environmental attributes associated with the chemical production network such as the carbon footprint, to the formulation additive as described in the context of FIGS. 1 to 3. The formulation additive producer may provide the environmental attributes associated with the formulation additive through the data providing service connected to the decentral network as described in the context of FIG. 4. The formulation additive user or the end product producer may access the environmental attributes associated with the formulation additive through the data consuming service connected to the decentral network as described in the context of FIG. 4.

The respective data owners in this example may be the input material producer, the output material producer, the output material user, the end product producer. The data owner may comprise any entity generating data. The data generating node may be coupled to the data owner or the entity owning or producing physical products from or for which data is generated. The data may be generated by a third-party entity on behalf of the entity owning physical products from or for which data is generated.

The data consuming service may comprise computer-executable instructions for accessing and/or processing data, such as formulation additive data, associated with the data owner. The data providing service may comprise computer-executable instructions for providing and/or processing data, such as formulation additive data, associated with the data owner for accessing and/or processing by the data consuming service.

In the example of FIG. 4 the decentral identifier may relate to the end product. Such decentral identifier may be provided to the value chain participants. Via the end product specific decentral identifier data associated with the end product produced from the formulation additive may be gathered across the production chain and assigned to the end product specific decentral identifier. for example, the one or more environmental attribute(s) associated with the end product may be derived from the environmental attribute(s) associated with the formulation additive, the input material or any other product entity present in the value chain of the end product.

This way the environmental attributes of input materials, formulation additive and any products produced from formulation additive may be tracked through the value chain up to the end product. By tracking the environmental attributes of materials in such way the information can be made transparent across the value chain while the information flow can be controlled by the participants in the supply chain. In addition, the environmental attributes can be handled according to the individual participants needs by production operating systems as described in the context of FIGS. 1 to 3. Overall, such tracking enables tracking of positive environmental impact by individual supply chain participants, which makes positive environmental impacts transparent and attributable to individual supply chain participants.

FIG. 6 illustrates schematically an example of a chemical production network for producing an aqueous polymer dispersion based product associated with the composition passport, or a passport providing regulatory information or a digital asset. The example of FIG. 6 is an illustrative example and should not be considered limiting.

In the example of FIG. 6 fossil feedstock, bio feedstock and recycled feedstock may be provided to the chemical production network for producing as an example a product containing a rheology modifier containing polyacrylic acid fully or partially neutralized with ammonia or mono or multivalent metallic cations using acrylic acid as monomer which may be the input material in this example as mixed feedstock. The rheology modifier may be used as component in a formulation containing at least one further component such as the other formulation compounds described before. By variation of these other formulation compounds different formulations may be produced. for example, using pigments, light and heat stablizer additives and fillers as other formulation compounds, paints, printing inks or resins may be produced.

In the example of FIG. 6 the chemical description and concentration of impurities in acrylic acid as input material may be tracked. As described in the context of FIG. 2, the chemical description and concentration of impurities in acrylic acid as input material at the start of the rheology modifier production chain may be registered via the production operating system 106. Here the chemical description and concentration of impurities in acrylic acid as input material may be allocated to the balancing account 112 for chemical description and concentration of impurities in acrylic acid as input material. The environmental attribute of chemical description and concentration of impurities in acrylic acid as input material is hence detached from the mass flows of the chemical processing in the chemical production network 102 as illustrated in FIG. 6.

For attribution of the chemical description and concentration of impurities in acrylic acid as input material used to produce the rheology modifier, the chemical description and concentration of impurities in acrylic monomers as input material may be determined. The chemical description and concentration of impurities in acrylic acid as input material attributable to “rheology modifier production may be based on mass conservation attributable to the produced rheology modifierrheology modifier. for example, only half of the chemical description and concentration of impurities in acrylic acid as input material may be attributable to the rheology modifierrheology modifier and the other half may be attributable to other output products resulting from the acrylic acid as input material. The environmental attribute chemical description and concentration of impurities in acrylic acid as input material may be attributed to such extend to the rheology modifier.

In the system shown in FIG. 2, the environmental attribute associated with the production of rheology modifier may be attributed to the produced rheology modifier by associating the decentral ID to the rheology modifier and assigning the environmental attribute to the decentral ID. By linking the ID and the environmental attribute, the environmental attribute may be uniquely linked to the produced rheology modifier. The rheology modifier may be delivered to the rheology modifier user. The packaging such as lose bags with rheology modifier may include a QR-code. The decentral ID may be included or encoded to the QR code. This way the rheology modifier user may access the environmental attributes associated to the rheology modifier via the ID based protocol described in the context of FIGS. 4 and 5.

Similarly to this example the chemical production network for producing rheology modifiers associated with the digital asset may be based on the method illustrated in FIG. 3 for carbon footprints.

1.-15. (canceled)

16. A system for producing a formulation additive associated with a digital asset, the system comprising:
a chemical production network configured to produce the formulation additive wherein the formulation additive is produced from one or more input material(s) through one or more chemical process(s) of the chemical production network, wherein the one or more input material(s) and/or the one or more chemical process(s) are associated with environmental attribute(s);
a production operating apparatus configured to generate the digital asset by providing a decentral identifier associated with the produced formulation additive and one or more environmental attribute(s) of the one or more input material(s) and/or the one or more chemical process(s);
linking the decentral identifier and the environmental attribute(s);
a chemical production network or system configured to provide each produced formulation additive in association with the digital asset.

17. The system of claim 16, wherein the formulation additive associated with the formulation additive passport or digital asset is selected from the group consisting of stabilizers, UV stabilizers such as UV absorbers and suitable free-radical scavengers (more particularly HALS compounds—hindered amine light stabilizers), activators (accelerants), driers, extenders, pigments, dyes, antistatic agents, flame retardants, thickeners, thixotropic agents, surface-active agents, viscosity modifiers, plasticizers or chelating agents, wetting agents, dispersion agents, emulsifier, defoaming agent, film forming agent/Coalescent, agents to reduce minimum film formation temperature, open time prolonger and slipping agents.

18. The system of claim 16, wherein the digital asset of the formulation additive includes information of impurities related to the input material(s).

19. The system of claim 16, wherein the one or more environmental attribute(s) associated with the formulation additive are provided from at least one balancing account configured to store environmental attribute(s) associated with input material(s).

20. The system of claim 16, wherein the one or more environmental attribute(s) are associated with at least one property related to the environmental impact of the one or more input material(s) and/or the chemical process(s).

21. The system of claim 16, wherein the production operating apparatus is configured to gather environmental attributes associated with the produced formulation additive before, during and/or after production of the formulation additive by the chemical production network.

22. The system of claim 16, wherein the environmental attribute(s) associated with the formulation additive produced through chemical processes from one or more input material(s) provided to the chemical production network include the environmental attribute(s) associated with the input material(s), the chemical process(es) and/or the chemical production network(s).

23. The system of claim 16, wherein the environmental attribute(s) associated with input material(s) are provided before, during and/or after production of the formulation additive by the chemical production network, wherein the environmental attribute(s) associated with input material(s) are allocated to at least one balancing account before, during and/or after production of the formulation additive by the chemical production network.

24. The system of claim 16, wherein the environmental attribute(s) associated with the produced formulation additive relate to environmental properties generated from process data associated with the chemical processing of the input material(s) and/or energy data associated with the energy consumption of the chemical processing, wherein the environmental attribute(s) associated with the produced formulation additive are generated before, during and/or after production of the formulation additive by the chemical production network.

25. A method for producing a formulation additive associated with a digital asset, wherein the method comprises:
producing the formulation additive from one or more input material(s) through one or more chemical process(s) of a chemical production network, wherein the one or more input material(s) and/or the one or more chemical process(s) are associated with environmental attribute(s);
generating the digital asset by
providing a decentral identifier associated with the produced formulation additive and one or more environmental attribute(s) associated with the one or more input material(s) and/or the one or more chemical process(s);
linking the decentral identifier and the one or more environmental attribute(s);
providing the produced formulation additive in association with the digital asset.

26. A formulation additive associated with a digital asset including a decentral identifier associated with the formulation additive and linked to one or more environmental attribute(s) of the one or more input material(s) and/or the one or more chemical process(s) used to produce the formulation additive.

27. The formulation additive of claim 26, wherein the formulation additive is selected from the group consisting of stabilizers, UV stabilizers, activators, driers, extenders, pigments, dyes, antistatic agents, flame retardants, thickeners, thixotropic agents, surface-active agents, viscosity modifiers, plasticizers or chelating agents, wetting agents, dispersion agents, emulsifier, defoaming agent, film forming agent/Coalescent, agents to reduce minimum film formation temperature, open time prolonger and slipping agents.

28. A method for generating a digital asset associated with a formulation additive, wherein the formulation additive is produced from one or more input material(s) through one or more chemical process(s) of a chemical production network, wherein the one or more input material(s) and/or the one or more chemical process(s) are associated with environmental attribute(s), the method comprising:
providing a decentral identifier associated with the produced formulation additive and one or more environmental attribute(s) of the one or more input material(s) and/or the one or more chemical process(s) used to produce the formulation additive;
linking the decentral identifier and the environmental attribute(s);
providing the digital asset in association with the produced formulation additive, wherein the environmental attribute(s) associated with the formulation additive is made accessible to a user of the formulation additive through the digital asset.

29. A digital asset as generated according to the method of claim 28.

30. A method comprising using the formulation additive of claim 26 associated with the digital asset for producing a product from the formulation additive and deriving a digital asset associated with the product from the formulation additive digital asset.
